(19) United States
(12) Patent Application Publication
(10) Pub. No.: US 2013/0339026 A1
(43) Pub. Date: Dec. 19, 2013

(54) PORTABLE ELECTRONIC REMINDER DEVICE

(71) Applicant: SHAWN LEE, CHARLOTTE, NC (US)

(72) Inventor: SHAWN LEE, CHARLOTTE, NC (US)

(21) Appl. No.: 13/915,808

(22) Filed: Jun. 12, 2013

Related U.S. Application Data
(60) Provisional application No. 61/658,947, filed on Jun. 13, 2012.

(51) Int. Cl. G06Q 10/10; G08B 21/24

(52) U.S. Cl. CPC G06Q 10/109; G08B 21/24
USPC 704/274; 340/669

(57) ABSTRACT

The invention is a portable electronic device that enables anyone to quickly schedule multiple voice reminders to play back at a specified time, date and frequency. Reminders can be either entered via voice command or manually via device keypad. Operation modes include voice, various audible alerts, visual alerts including but not limited LED lights, silent or vibration as well as motion detection activated. A microprocessor running under the control of a software program controls the keypad and electronic subsystems to implement the device.

### FIELD OF THE INVENTION

The presently disclosed subject matter is directed toward message recall devices. More particularly it is directed to mobile devices that record and then playback messages and reminders at predetermined times or on occurrences of motion being detected or playback controls being pressed.

### BACKGROUND OF THE INVENTION

Forgetting appointments, birthdays, where and when to meet, passwords, and phone numbers can all be highly frustrating and detrimental, both financially and socially. Avoidable embarrassments, wasted time and money, lost efforts and unwanted stress can, and do result. Thus the need for a good memory.

While forgetfulness may not always be fatal, it can be. Those required to take medications, such as the elderly, may suffer serious harmful effects, including death, if they do not take medications on schedule.

Advancing age compounds memory problems. As one ages memory retention decreases while recall problems increase. Age related memory problems are not a minor problem. There are currently about 58 million people 60 years or older in the US, about 19% (2010 US Census) of the total population. In fact, more people were 65 years and over in 2010 than in any previous census. Between 2000 and 2010, those 65 years and over increased at a faster rate (15.1 percent) than the total U.S. population (9.7 percent). In addition, the largest percentage increase over the last two decades was in the 90 to 94 year old age group, which increased 25.0 percent. In addition to those currently over 65, the “Golden Boomers” with a population of about 76 million are just now starting to enter the 65 years and older group at a significant rate.

An aging population combined with the continual increase in information and the speed of daily life present growing challenges for all ages.

In view of the foregoing, devices that relieve some of the burden of having to recall events would be beneficial. Even more beneficial would be devices that not only relieve some of the burdens of having to recall events but that are easy to use, automated, lightweight, durable, and mobile. Preferably such devices would enable a user to easily and quickly record voice reminders and schedule playback, either audibly or by vibration at a specified date, time, or frequency, or that can be set up to automatically trigger playback when motion is detected.

### BRIEF SUMMARY OF THE INVENTION

The principles of the present invention provide for message devices that serve to relieve the problems of having to recall things. Such message devices leverage the familiarity of handheld devices into automated memo pad that are lightweight, durable, and mobile. Such message devices can be located in position using belt clips, magnet, and adhesives. Message devices in accord with the present invention enable users to easily and quickly record voice reminders and schedule playback or vibration at a specified date, time, frequency or when triggered via a motion sensor.

One embodiment of the present invention is a portable reminder device that includes a keypad and buttons for starting memo recording and for entering data. That embodiment has a keypad, includes digit keys 0-9, a Start key for starting message recording, an End key for ending message recording, a Menu key for initiating a menu, a Mon key for entering Monday, a Tues key for entering Tuesday, a Weds key for entering Wednesday, a Thur key for entering Thursday, a Fri key for entering Friday, a Sat key for entering Saturday, a Sun key for entering Sunday, an AM key for entering AM, a PM key for entering PM, an UP key for selecting next, a DOWN key for selecting previous, a Freq key for entering the frequency of message playback, and a Memo key for commanding a memo. The portable reminder device also includes a microprocessor running a software program and which is operatively connected to the keypad. The software program causes the microprocessor to decode the keypad keys when they are pressed.

That embodiment includes a display that is operatively connected to the microprocessor for supplying visual information as directed by the microprocessor; a vibration system operatively connected to the microprocessor for signaling a user by vibration when commanded by the microprocessor; a clock system operatively connected to the microprocessor for providing system time to the microprocessor, and an internal battery for providing operating power; and an On-Off power switch for selectively supplying electrical power from the battery to operate the portable reminder device. The portable reminder device operates under software controls such that the microprocessor enables a user to record a message and play it back at a predetermined time and date.

A portable reminder device that is in accord with the present invention includes a microprocessor running a software program, a sound system for emitting prompts and recorded messages, a microphone for receiving voice messages and instructions, an audio processing system operatively connected to the microphone, to the sound system, and to the microprocessor, the audio processing system for digitizing received voice messages and instructions and for applying digitized voice messages and instructions to the microprocessor. The audio processing system emits prompts and recorded messages to the sound system when prompts and recorded messages are received from the microprocessor. The portable reminder device further includes a memory operatively connected to the microprocessor for storing data from the microprocessor and for applying stored data to the microprocessor when commanded by the microprocessor, a vibration system operatively connected to the microprocessor for signaling a user by vibration when commanded by the microprocessor, a motion sensor operatively connected to the microprocessor for sensing motion, and clock system operatively connected to the microprocessor for providing system time, an internal battery for providing operating power, and an On-Off switch for selectively supply electrical power from the battery to operate the portable reminder. The portable reminder device also includes a motion mode control switch for causing the microprocessor to enter a motion mode. Software controls the microprocessor so as to enable a user to record a message and to play it back at a predetermined time. That software also controls the microprocessor to play back a message when the microprocessor is in the motion mode.

The portable reminder device may include a keypad that is operatively connected to the microprocessor, where the keypad is used to enter data. If used, the keypad may include digit keys 0-9, a Start key for starting message recording, an End key for ending message recording, a Menu key for initiating a menu, a Mon key for entering Monday, a Tues key for entering Tuesday, a Weds key for entering Wednesday, a Thur key for entering Thursday, a Fri key for entering Friday, a Sat key for entering Saturday, a Sun key for entering Sunday, an AM key for entering AM, a PM key for entering PM, an UP key for selecting next, a DOWN key for selecting previous, a Freq key for entering the frequency of message playback, and a Memo key for commanding a memo. If so, pressing the Start key initiates message recording and pressing the End key ends message recording.

In the portable reminder device the microprocessor causes the sound system to emit a prompt to signal start of recording. Beneficially, the audio processing system digitizes a message, the microprocessor receives the digitized message, and the microprocessor causes the memory to store the digitized message. In practice recording ends when a key is released. Beneficially the microprocessor recognizes audible entry of the day of the week a recorded message is to be played back. Preferably, the microprocessor operates in a plurality of operating modes, beneficially including a vibration mode wherein sound is suppressed and vibrations are used for signaling. The portable reminder device may include a display that is operatively connected to the microprocessor, where the display presents visual messages to a user. The portable reminder device may include at least one LED for visually signaling an operating mode.

With the portable reminder device a playback key operatively connected to the microprocessor causes a recorded message to be played back when pressed. Typically that will be the first recorded message. In another operating mode the motion sensor senses movement around the portable reminder device. Preferably the clock system automatically obtains current time from an external source. For convenience the portable reminder device may include a belt clip, a magnet and/or an adhesive strip for attaching the portable reminder device to a surface.

### BRIEF DESCRIPTION OF THE DRAWINGS

The advantages and features of the present invention will become better understood with reference to the following detailed description and claims when taken in conjunction with the accompanying drawings, in which:

FIG. 1 is a view of a user using a handheld memo device 100, 200 which is in accord with the present invention;

FIG. 2 is a front view of a first embodiment handheld memo device 100;

FIG. 3 is a rear view of the memo device 100 shown in FIGS. 1-2;

FIG. 4 is a top down view of the memo device 100 shown in FIGS. 1-3;

FIG. 5 is a bottom up view of the memo device 100 shown in FIGS. 1-4;

FIG. 6 is a right side view of the memo device 100 shown in FIGS. 1-5;

FIG. 7 is a left side view of the memo device 100 shown in FIGS. 1-6;

FIG. 8 is a schematic block diagram of the memo device 100;

FIG. 9 is a front view of a second embodiment handheld memo device 200;

FIG. 10 is a rear view of the memo device 200 shown in FIG. 9;

FIG. 11 is a side view of the memo device 200 shown in FIGS. 9 and 10; and

FIG. 12 is a schematic depiction of the memo device 200 shown in FIGS. 9-11.

### DESCRIPTIVE KEY

1. Start Key

2. Key 7 and Sun

3. Display

4. Key 2 and Tue

5. First LED

6. Speaker

7. Second LED

8 Key 5 and Fri

9. Scroll Up/Down

10 Key 6 and Sat

11. Key 3 and Wed

13. PM

14. AM

15. Key 4 and Thr

16. Key 8 and Freq

17. Key 9 and Mode

18. Key 0 and Memo

19. Key 1 and Mon

20. END or Menu

33. Casing—Material surrounding device

39. Magnetic belt clip

48. Microphone

53. Battery Compartment Cover

60. Volume UP

63. Volume DOWN

70. Power switch

100. first embodiment memo device

200. second embodiment memo device

206. On-Off button

208 Play button

210. Record button

212 Motion button

214 Timer button

216 Vibrate button

218 Volume button

220 Clock button

222 magnet

224 clip

226 adhesive strip

228 motion LED

230 timer LED

232 vibration LED

234 power LED

236 Clock LED

238 vibrator

240 message LED

306 various LEDs

802 Microprocessor

806 Keypad

812 Motion sensor

### DETAILED DESCRIPTION OF THE INVENTION

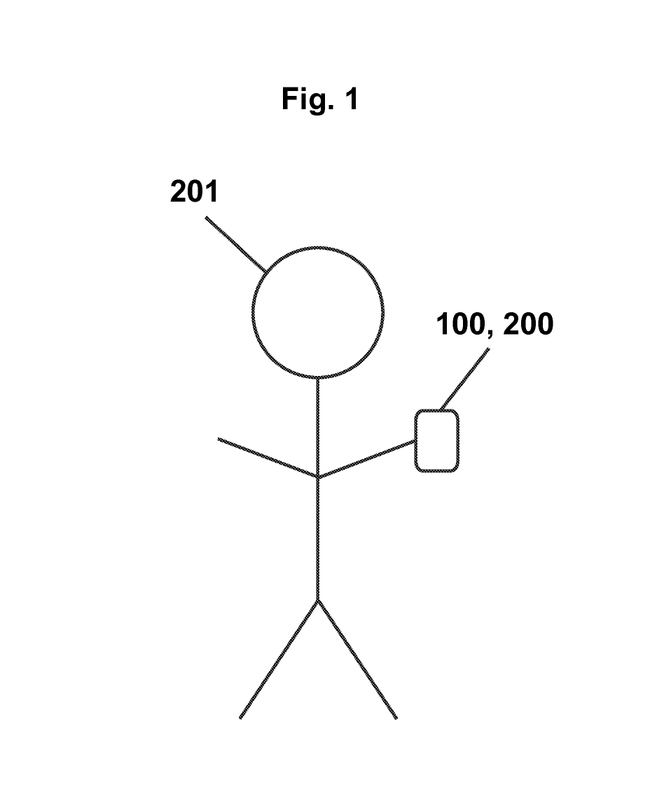

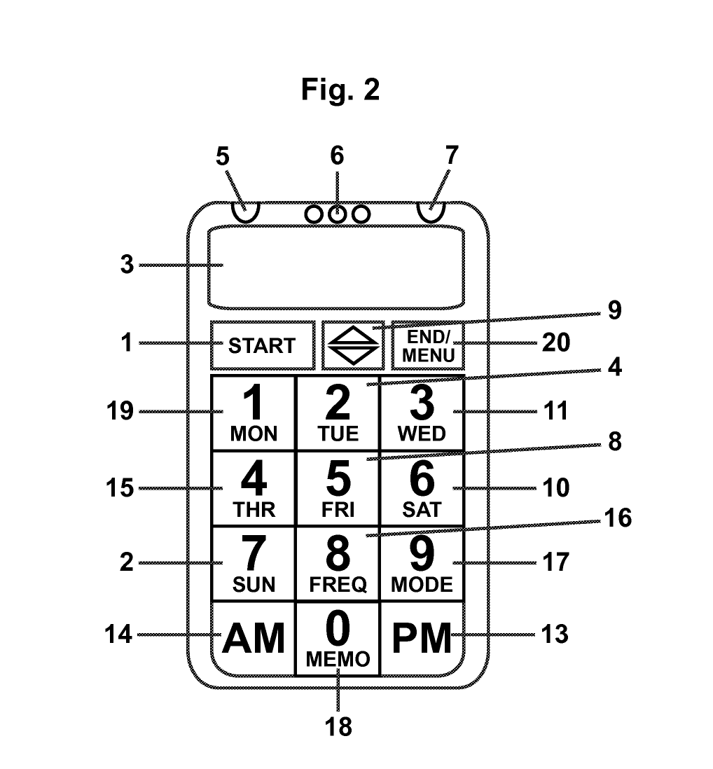

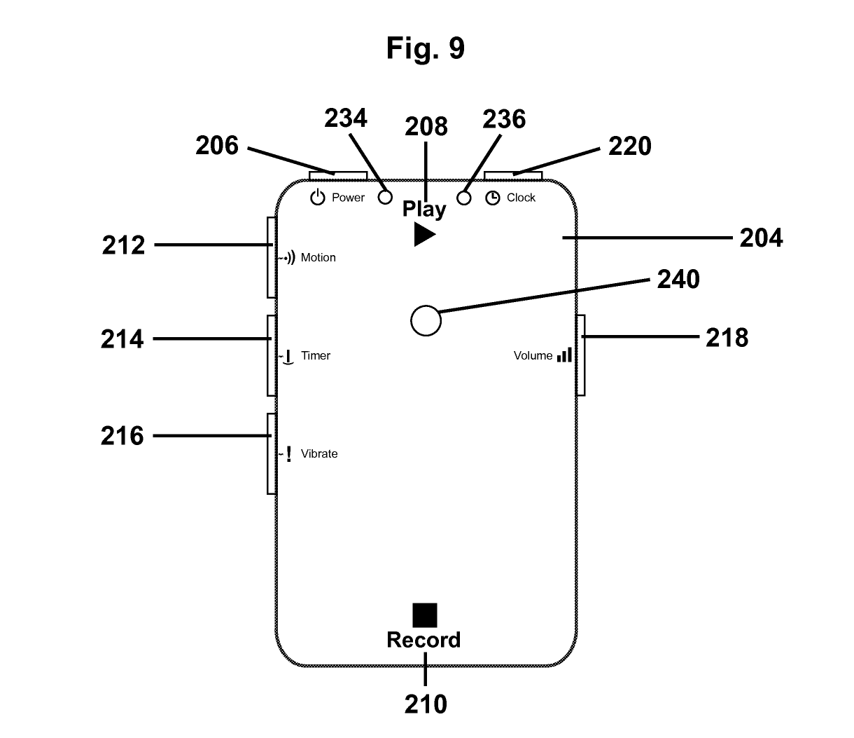

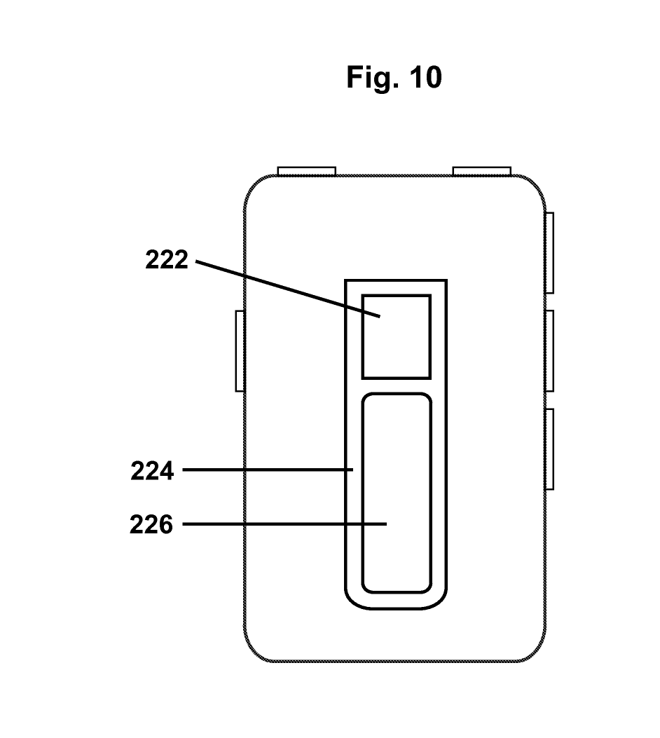

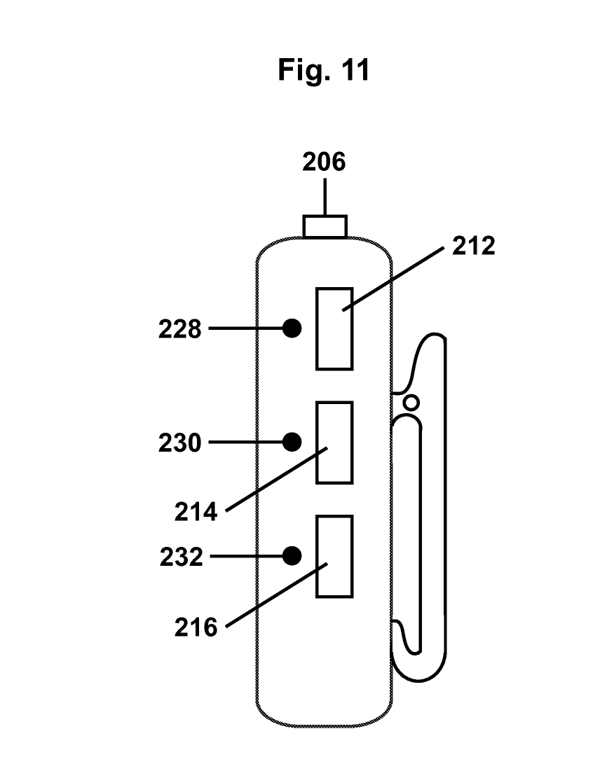

A first embodiment of the present invention is depicted in FIGS. 2 through 8 while a second embodiment is illustrated in FIGS. 9-12. FIG. 1 depicts a user 201 carrying either the first embodiment or the second embodiment. However, the invention is not limited to the specifically described embodiments. A person skilled in the art will appreciate that many other embodiments of the invention are possible without deviating from the basic concept of the invention. Any such work around will also fall within the scope of this invention.

In the figures like numbers refer to like elements throughout. The terms “a” and “an” as used herein do not denote a limitation of quantity, but rather denote the presence of at least one of the referenced items.

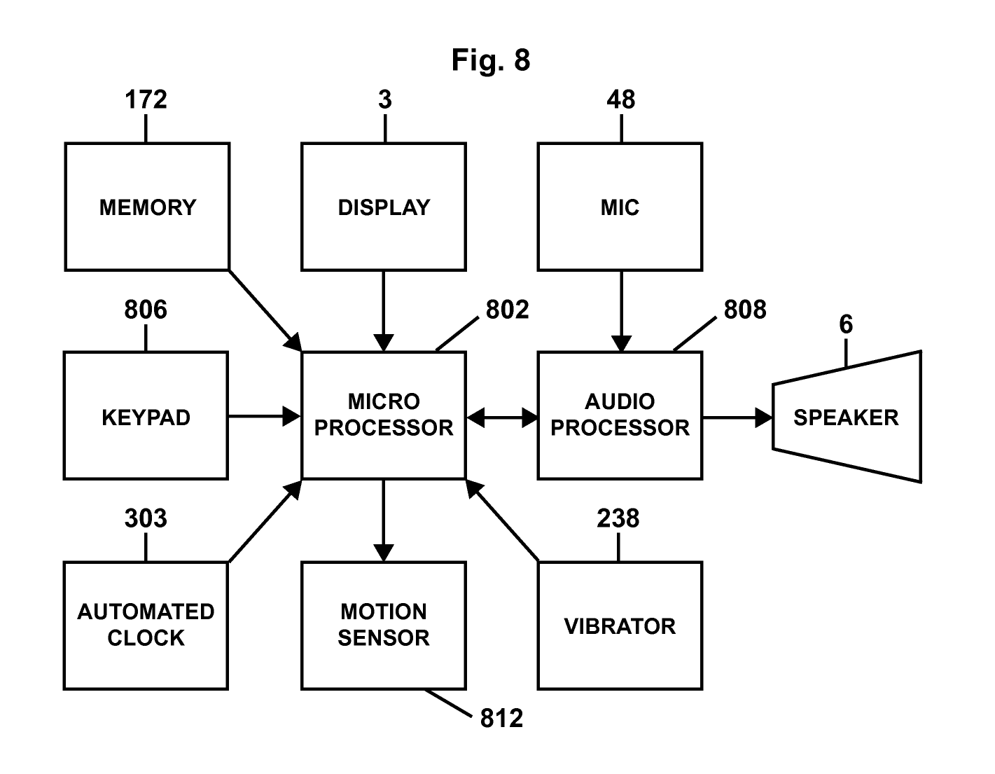

The first embodiment of the present invention makes extensive use of a keypad (or virtual keypad) 806 (see FIG. 8), while the second embodiment dispenses with the keypad 806. The keypad 806, like many keypads, includes individual keys for the digits 0-9, as well as start, stop, and direction keys. Some of those individual keys have dual functions. For example, the keypad key for entering the digit 1 is also used to enter Mon (for Monday). The need for dual keys in the first embodiment somewhat complicates the description of that embodiment since individual key operations must be described in sufficient detail to enable one skilled in the art to practice the invention. For clarity the following element numbering scheme is used. When a keyboard key is referred to, such as the key for the both digit 1 and Mon, for clarity the designator for that key is provided in parenthesis. For example, the keypad key with the digit 1 and Mon has a designator (19). Thus when discussing that key when entering 1 it is referred to as key 1 (19). As another example, the Start key is designated as Start key (1). However, in the second embodiment parenthetical identification is not required and is not used.

The following describes microcontroller or microprocessor based devices having numerous capabilities. One embodiment is a memo device 100 that incorporates a digital display, keyboard scanning, memory, a digital clock, digital audio recording, playback, and voice recognition subsystems, as well as a motion sensor. The other embodiment incorporates individual control buttons; a digital clock; digital audio recording, playback, and voice recognition subsystems; as well as a motion sensor. Both embodiments involve interactions of hardware and software. The required hardware and software programming applications are readily available and commonly used by those skilled in the applicable arts, as is well-known to electrical engineers, scientists, highly skilled electronic technicians, and electronic hobbyists. For example, suitable microprocessors, microcontrollers, and micro-based systems are widely available from manufacturers such as Arduino™, Atmel™, MicroChip™, NXP™, FreeScale™ (Motorola), Hitachi™, Intel ™ 8051 derived devices such as from Silicon Labs™, Texas Instruments™, and numerous others. Commonly used software tools include C, Basic, and Assembly. Suitable system programmers, design boards, instructions, manuals, white papers, board layout tools, and implementation aids are widely available and commonly used. Required support devices such as motion sensors (for example, using ultrasound), memories, keypads, and buttons are also widely used and available. Consequently, implementing a device in accord with the principles of the present invention is an engineering process that can be performed by those skilled in the art using commonly available tools, devices, and elements.

FIG. 1 illustrates a user 201 using either a handheld memo device 100 or a handheld memo device 200 that is in accord with the present invention. The memo devices 100 and 200 are highly portable, internally powered, small in size, dimensioned to fit the hands, lightweight and easily carried.

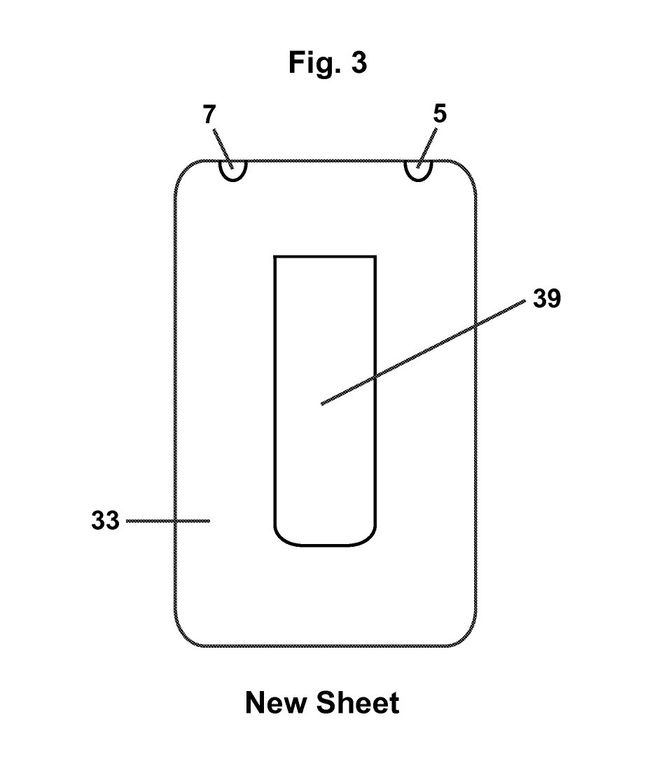

FIG. 2 is a front view of the first embodiment memo device 100 which includes a keypad 806 (reference FIG. 8 and the subsequent discussions). The memo device 100 stores messages, provides reminders at predetermined times and under predetermined conditions, and assists in recalling stored information. To assist carrying the memo device 100 it includes a magnetic belt clip 39 (see FIGS. 3-7). Either the clip portion or the magnet portion of the magnetic belt clip can be used to attach the memo device 100 to a desired place.

First the memo device 100 must be turned on or activated. Referencing FIG. 7, assuming the memo device 100 is off, a user turns the memo device 100 on by switching side accessible Power switch 70 to the ON position. Alternatively or additionally, the device may be activated by moving the device from a first location or position to a second location or position.

Referring now to FIG. 2, with the Power switch 70 ON a user presses the Start key (1) to initiate recording. The memo device 100 then audibly emits sound 6 and shows on a display 3: “Enter the time you want reminded and press END” or some similar instructions to the user.

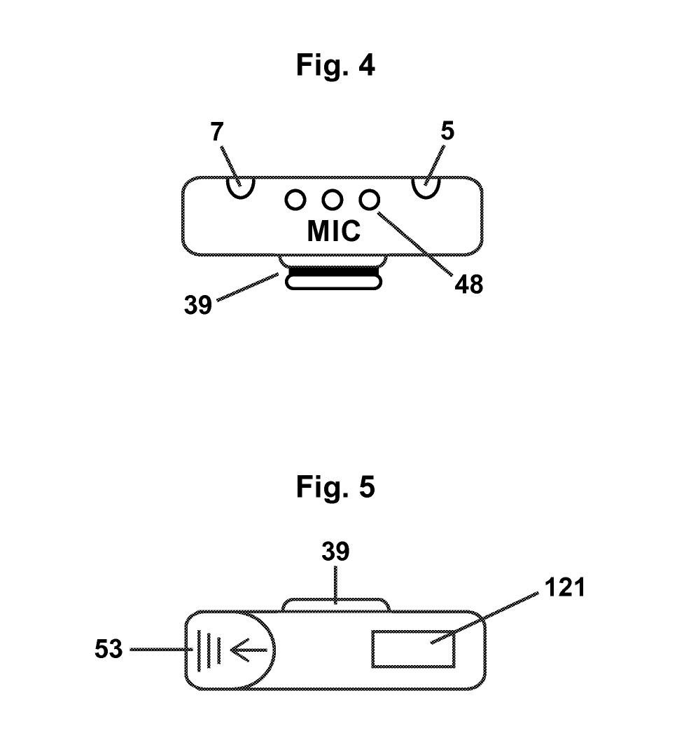

In response, a user either verbally speaks the time into a microphone 48 (see FIG. 4) or manually enters information into the device using the key pad 806 and then presses the END key (20). The memo device 100 includes an audio processor 808 (see FIG. 8) having a voice recognition subsystem. If a user command is verbally spoken the signal input from the microphone 48 is analyzed by the voice recognition subsystem, the command is interpreted and sent as data entry to the microprocessor 802. The microprocessor 802 then enters the command. This process of receiving and analyzing spoken commands is the same for all commands that can be entered verbally. Thus the description of the process will not be repeated.

After time is entered, the memo device 100 emits sound 6 and shows on the display 3 “Enter AM or PM and press the END when done” or similar directions. In response, the user either speaks AM or PM into the microphone 48 or manually enters AM using the AM key (14) or PM using the PM key (13), and presses the END key (20).

Next, the memo device 100 automatically emits sound 6 and shows on the display 3 “Enter the day of the week by pressing key number 1 (19) for Monday, key number 2 (4) for Tuesday, key number 3 (11) for Wednesday, key number 4 (15) for Thursday, key number 5 (8) for Friday, key number 6 (10) for Saturday or key number 7 (2) for Sunday and then press END when done” or similar directions.

In response the user either speaks the day of the week into the microphone 48 (see FIGS. 4 and 8) or manually enters that day into the memo device 100 using the appropriate individual keys and then presses the END key (20). Alternatively the user might enter the date verbally into the microphone 48 or manually by the keypad 806 in a DD/MM/YYYY format and then pressing the END key (20).

After the date is entered the memo device 100 automatically emits sound 6 and shows on the display 3 “Enter frequency, say “Once” for once, “Daily” for daily or “Weekly” for weekly and then press END″ or similar directions to the user. In response the user either speaks the frequency into the microphone 48 or manually enters the information into the memo device 100 using the keypad 806 and then presses the END key (20).

After the frequency is entered the memo device 100 automatically emits sound 6 and shows on the display 3 “Enter mode, Sound, Vibrate or Detect Motion and press END” or similar directions. In response the user speaks the desired mode into the microphone 48 or manually enters it into the device using the MODE key (17) and then presses the END key (20).

After the mode is entered, the memo device 100 automatically emits sound 6 and shows on the display 3 “Say the message you want to be reminded of and press END when done” or similar directions. In response, the user speaks the desired message into the microphone 48 and when complete presses the END key (20).

After the message is entered, the memo device 100 automatically emits sound 6 and shows on the display 3: “Time, AM or PM, Frequency and Message” or similar directions to the user.

For simplicity the memo device 100 allows users to record a memo with no specified date, time or frequency. Referencing FIG. 7, assuming the memo device 100 is off a user turns the memo device 100 on by switching the Power switch 70 to the ON position.

Referencing FIG. 2, next, a user presses the MEMO key (18) to initiate the Memo functionality. The memo device 100 audibly emits sound 6 and shows on the display 3: “Press START to record new memo or press 1 to play a previously recorded memo” or similar directions.

To record a new memo, the user presses the START key (1) to initiate recording then speaks the message into the memo device 100. When finished the user presses the END key (20). In response the memo device 100 automatically emits sound 6 and shows on the display 3: “Recorded Memo and the automatically assigned number” or something similar. Beneficially numbering is sequential.

To play a pre-recorded memo a user presses the digit key 1 (19) to play pre-recorded memos. In response the memo device 100 automatically emits sound 6 and shows on the display 3: “Memo 1, to move forward to another memo press the up arrow” or something similar. After a short delay the memo device 100 audible emits recorded memo 1.

However, if a user presses the up arrow (9) the memo device 100 sequentially moves to the next previously recorded memo emits sound 6 and shows on the display 3: “Memo #, to move forward to another memo press the UP arrow, when done press END” or something similar. The memo device 100 then automatically emits the recorded memos in sequential order until the user presses the END key (20) or the memo device 100 plays all memos.

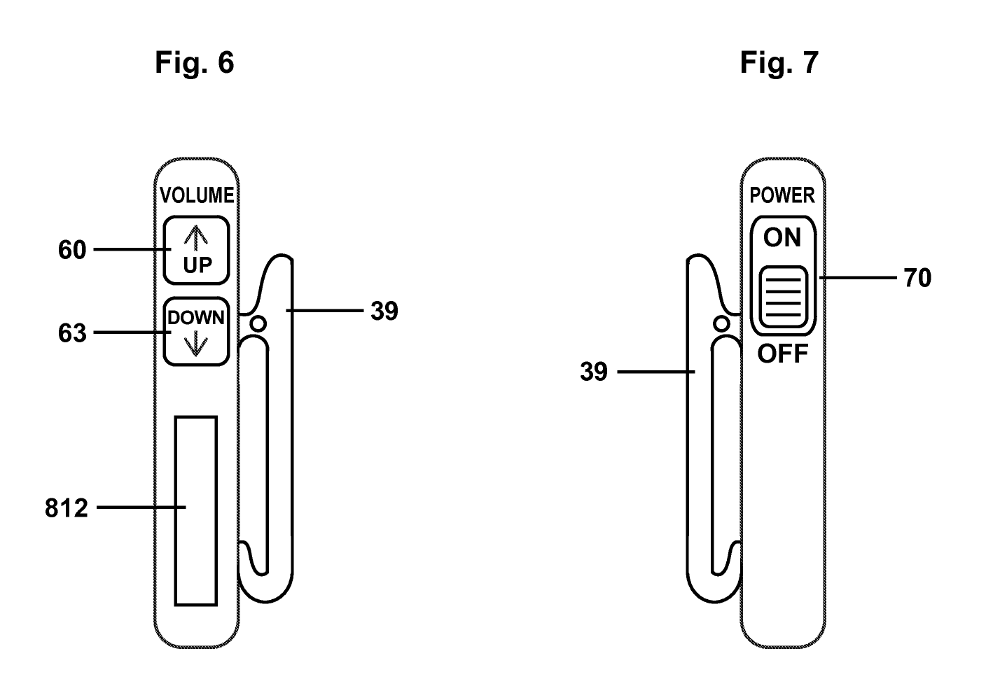

In view of the wide range of operating modes, to assist the user the memo device 100 can be preconfigured to run in a desired operating mode. In a sound mode the memo device 100 plays recorded messages back at previously specified times, days/dates and at a predetermined frequency. Sound volume may be adjusted using the volume UP and DOWN buttons 60 and 63, see FIG. 6, or by activating virtual keys, or by audible inputs for increasing or decreasing volume, or combinations thereof.

In vibrate mode the memo device 100 does not emit sound but instead vibrates and flashes the first LED 5 and the second LED 7, see FIG. 2.

In motion detection mode the memo device 100 plays recorded messages back when motion is detected via the built in motion sensor 812 (see FIG. 8). A user can cause motion to be detected by walking past the memo device 100, or by moving or causing motion within a predetermined proximity of the device.

It should be noted that in all modes the memo device 100 continues to emit reminders until the user presses the END key (20) or audibly deactivates the reminders. Individual reminders may be ended or deleted, or all reminders may be ended or deleted or canceled.

To increase the utility of the memo device 100 it is equipped with an Automated Clock 303 (see FIG. 8) for highly accurate timekeeping. A user selects a time zone and the memo device 100 automatically synchronizes time with the time available from radio signals emitted by the United States Government from Boulder, Colo. or from another highly accurate time source. The Automated Clock 303 beneficially adjusts for Daylight Savings Time changes as needed.

Alternatively the user sets and adjusts the clock/time manually via the MENU key 20 or verbally using the microphone 48 (see FIG. 4).

The memo device 100 is beneficially powered by a small battery 53 that is recharged by a solar cell 121, see FIGS. 5 and 8.

For convenience the memo device 100 is equipped with the magnetic belt clip 39 (see for example FIGS. 3-7). The magnetic clip 39 allows a user to use it as a belt clip, as a general clip, or as a magnetic clip useful for attaching the memo device 100 to anything ferromagnetic.

Beneficially, the memo device 100 includes a case 33 that provides shock resistance and water resistance for the memo device 100.

Because of the capabilities of the memo device 100, its memory 172 (see FIG. 8) can be increased as required to properly service a user. For example, the memory 172 may be expanded by using a Micro-SD card.

FIG. 8 presents a schematic block diagram of the electronic systems used in the memo device 100. The electronic system includes the automated clock 202, the keypad 806, memory 172, the display 3, the microprocessor 802, a motion sensor system 812, the mic 48, the audio processor 808 having the voice recognition subsystem, and the speaker 6.

The motion sensor system 812 senses motion. The motion sensor system 812 is very useful when retrieving messages by motion. For example, every time a user passes by the memo device 100 the device would play a pre-recorded message (for example, “take out the trash” or “get milk”. When the user selects “Motion” mode by using the keypad 806 or by speaking “Motion” the microprocessor 802 displays “Motion” on the display 3 and causes an audio processor 808 to emit “Motion” from the speaker 6. Then whenever someone passes by the memo device 100 the memo device 100 plays the latest message.

While the first embodiment memo device 100 is highly useful it is not necessarily optimal in all applications. For example, given the current state of audio processing and user desires for smaller, lower cost, and easier to use memo devices a device that does not need or incorporate a keypad 806 may more useful. The second embodiment memo device 200 shown in FIGS. 9-12 may be more useful to some users.

Turning now to FIG. 9, the memo device 200 is smaller and lighter than the memo device 100. This is at least partially because the memo device 200 does not incorporate a keypad 806.

The memo device 200 must first be turned on. Referencing FIG. 9, assuming the memo device 200 is turned off, a user turns the memo device 200 on by pressing an On/Off button 206. In response a beep is sounded to signal that the memo device 200 is turned on. To turn the memo device 200 off the On/Off button 206 is pressed again. Thus powering on and off alternates as the On/Off button 206 is depressed. In an alternate embodiment, moving the device (picking it up) activates it or “turns it on”. Correspondingly, if the device is not moved within a predetermined time (e.g., five minutes) it powers off to conserve power. If a memo or reminder is pending, it automatically reactivates when the motion sensor activates it (user passes by or if the device is moved).

With operating power applied a user initiates recording by pressing and holding a record button 210. In response to the depression of the record button 210 the memo device 200 says “Recording,” or something similar, and emits a beep that signals the start of recording. The memo device 200 then records until the user releases the record button 210. In response to the record button 210 being released the memo device 200 says “Recording Stopped,” or something similar, and emits a beep that signals the end of recording. Beneficially recording is limited to 60 seconds to conserve power. In an alternative embodiment, a touch screen or interactive GUI or virtual key is provided for activation, or in addition to a physical button to depress. Also, in another embodiment, the device automatically activates when moving and prompts the user to create a reminder. The device may automatically activate an alert if no reminder has been made or motion sensed within a predetermined timeframe (e.g., one week).

After recording the user can play the recorded message back. To do so a user presses a Play button 208. In response, the memo device 200 plays back the recorded message and automatically stops when finished. In alternate embodiments, the user activates a Play function by stimulating a corresponding virtual key on an interactive graphical user interface (GUI) and display or via voice command.

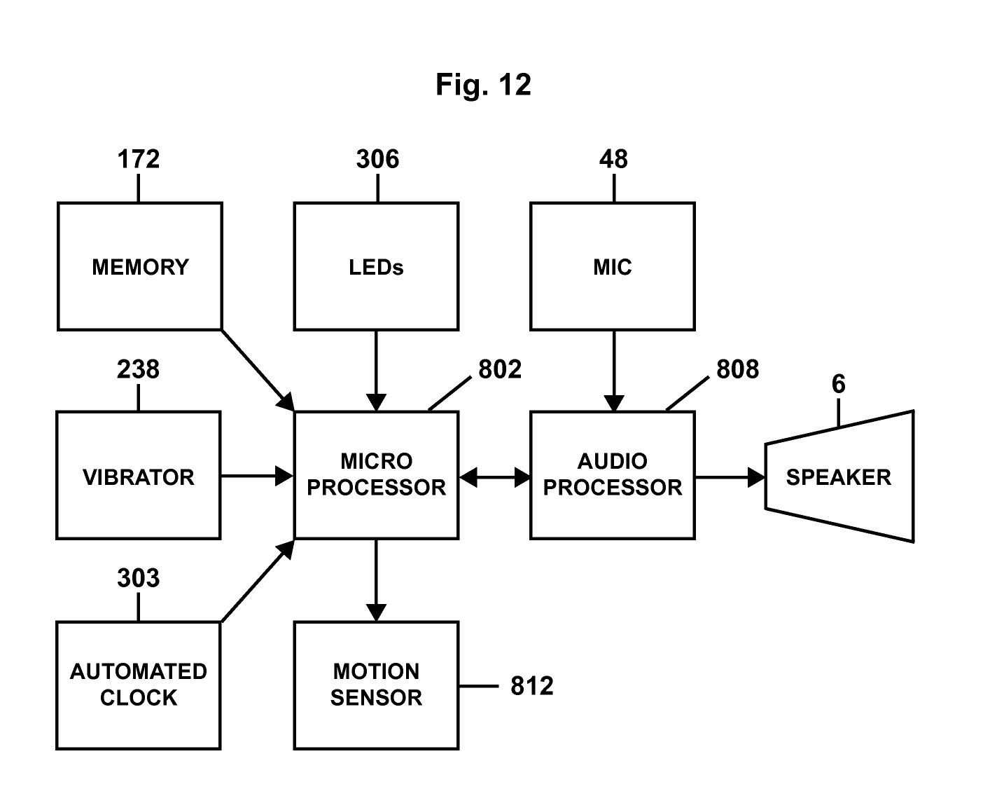

The foregoing description of playing back messages is only one of the operating modes of the memo device 200. In most instances the memo device 200 is used to automatically playback messages or reminders at predetermined times, frequencies or after detection of motion. To playback messages at predetermined times or frequencies it is important for the memo device 200 to associate the messages with the time predetermined for playback, and to provide for automatic playback at those times corresponding to the messages. This is accomplished using a fully automated clock 303 or other timer or time device as previously discussed with regard to the memo device 100 and as shown in the schematic diagrams of FIGS. 8 and 12.

Alternatively, to manually set the automated clock 303 a user presses a Clock button 220. In response to the depression of the Clock button 220, the memo device 200 says “Set Clock,” or some similar message, illuminates a Clock LED 236, and activates a voice prompted process that directs the user to set the time and date of the automated clock 303. For example, the memo device 200 asks the user to verbally enter the current month, date, hour, minute and AM/PM. After that information is entered the memo device 200 prompts the user to confirm the entered information. The memo device 200 speaks back the month, date, hour, minute, and AM/PM and asks for user confirmation. If the user confirms the ongoing clock setting mode is ended. If not confirmed the user would be asked to re-enter the information. The process would continue until the user confirms the current time. After confirmation the memo device 200 would emit a beep to signal completion of time entry and the Clock LED 236 would turn off

Alternatively, if the Clock button 220 is pressed the memo device 200 in some applications would ask the user to verbally select a month (such as by saying YES) and then the device would speak January, February etc. until the user says yes. This process is repeated for day, hour, minute, and AM/PM until the memo device 200 is programmed with the correct time.

In all but vibration mode (see below) the playback volume and the intensity of the beeps or audible alerts or notifications are important. Preferably, the audible alerts or notifications are within a range of normal human hearing. If too loud, using the memo device 200 would be uncomfortable and possibly unacceptable. If too low, the memo device 200 might be unusable. To properly adjust the volume the memo device 200 includes a push-button volume control 218. When the volume control 218 is pressed the device beeps at the current volume as the volume cycles up to a maximum and then down to a minimum and then back up. The maximum volume should enable the memo device 200 to be heard from about 25 feet away.

One highly beneficial mode of operation of the memo device 200 is active motion sensing. To support motion sensing the memo device 200 incorporates a motion sensor 812 as described above and as shown in FIG. 12. The active sensing mode is entered when a user presses a Motion button 212. When the Motion button 212 is pressed the device activates the motion sensor and a motion LED 228 located next to the Motion button 212 lights. To extend battery life the motion LED 228 blinks in bursts of 3 every minute. In the motion sensing mode the memo device 200 plays back the last recorded message every time motion is detected, such as when a user walks by the memo device 200. When the motion button 212 is pressed again the active motion sensing mode is left, the motion LED 228 goes out, and the device no longer plays a message when nearby motion occurs. Preferably, the motion sensor detects external motion within at least about five feet from the device. Also, preferably, the motion sensor detects external motion within a range of between about less than one foot and about three feet from the device.

Modern society sometimes frowns on beeps and other sounds from devices. To prevent unwanted sound emissions the memo device 200 incorporates a vibrator 238 (see FIG. 12) and a vibration mode. To enter the vibration mode, a user presses a vibrate key 216. When the Vibrate key 216 is pressed the vibrate mode is entered, the memo device 200 turns off all sound emissions such as beeps, the vibrator 238 is enabled to signal playback times, a vibrate LED 232 next to the vibrate button 214 flashes 3 bursts every minute to indicate the vibration mode is active, and automatic play back of recordings and messages is disabled.

When in vibrate mode the memo device 200 will vibrate at pre-selected times (see below). In addition, a large message LED 240 will blink starting at the pre-selected time until a user presses the play button 208. However, even though recordings and messages will not automatically play back in vibration mode a user can still force playback by pressing the play button 208 as usual. Once the message is either played back or acknowledged by the user pressing a button the message LED 240 turns off.

Automatic playback is integrally related to the automated clock 303 or an alternate timer device. If the memo device 200 does not include a keypad 806, or virtual keypad, setting the playback time is accomplished by audio commands. To set the playback time a Timer button 214 is pressed. When the timer button 214 is pressed a timer LED 230 next to the timer button 214 lights and a voice operated time selection process that enables a user to set a specific time and date for recording play back or vibration is entered. The timer LED 230 blinks in bursts of 3 every minute to save battery power. The memo device 200 asks the user to enter the time of playback/vibration. In response, the user speaks the time of playback, including either AM or PM. The memo device 200 then repeats the time and asks for confirmation. A user confirms the time or commands that the playback/vibrate time be re-entered; this user input may be audible or by other user inputs, activation of a physical or virtual key, or combinations. If the time was incorrect the processes is repeated until the user confirms the playback/vibrate time. Once the playback/vibrate time is entered the memo device 200 asks for the playback/vibrate date. In response, the user speaks the playback/vibrate date. The memo device 200 then repeats the date and asks for confirmation. A user then either audibly confirms the date or commands that the playback/vibrate date be re-entered. Once the correct playback time is confirmed the timer LED 230 is turned off.

FIG. 12 presents a schematic block diagram of the electronic systems used in the memo device 200. The electronic system includes the automated clock 303, memory 172, the various LEDs 306 (including the LEDs 228, 230, 232, 234, 236 and 240), the microprocessor 802, a motion sensor system 812, the mic 48, the audio processor 808 having a voice recognition subsystem, and a speaker 6.

In a method for automated reminders the present invention includes the steps of: providing a portable reminder device operable for providing automatic reminder alerts having an audio notification and/or a visual notification; activating the portable reminder device; creating a new reminder on the portable reminder device; activating a motion sensor on the portable reminder device so that when motion is detected, the portable motion sensor device automatically activates at least one reminder notification or alert. Also, the step of automatically activating at least one reminder notification or alert further includes the step of automatically generating an audible signal. Furthermore, the step of automatically activating at least one reminder notification or alert further includes the step of automatically generating a visual signal.

The present invention includes alternative embodiments to physical keys for activating functions on the device. By way of example and not limitation, virtual keys are provided on a virtual keyboard by a graphical user interface (GUI) with predetermined areas on a display that provides for touch-screen selection and/or activation of functions when the device automatically detects pressure on the display or screen or visual proximity to the display or screen for those images or icons representing virtual keys.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed:

1. A portable reminder device, comprising:
a microprocessor running a software program;
a sound system for emitting prompts and recorded messages;
a microphone for receiving voice messages and instructions;
an audio processing system operatively connected to said microphone, to said sound system, and to said microprocessor, said audio processing system for digitizing received voice messages and instructions and for applying digitized voice messages and instructions to said microprocessor, said audio processing system further for emitting prompts and recorded messages to said sound system when said prompts and recorded messages are received from said microprocessor;
a memory operatively connected to said microprocessor, said memory for storing data from said microprocessor and for applying stored data to said microprocessor when commanded by said microprocessor;
a vibration system operatively connected to said microprocessor for signaling a user by vibration when commanded by said microprocessor;
a motion sensor operatively connected to said microprocessor, said microprocessor for sensing motion;
a motion mode controller for causing said microprocessor to enter a motion mode;
a clock system operatively connected to said microprocessor for providing a system time;
an internal battery for providing operating power; and
a switch for selectively supplying electrical power from said battery to operate the portable reminder;
wherein said software controls said microprocessor to enable receiving inputs from a user to record a message and to play it back at a predetermined time; and
wherein said software controls said microprocessor to play back the message when said microprocessor is in said motion mode.

2. The portable reminder device according to claim 1, further including a keypad operatively connected to said microprocessor, said keypad for entering data.

3. The reminder device according to claim 2 wherein said keypad includes a plurality of keys that each correspond to and activate a predetermined function, the predetermined functions including selecting single digit numerals, selecting day of the week, and message recording, message activation, message playback frequency, memo function, and combinations thereof.

4. The portable reminder device according to claim 1, wherein activating a start key initiates the message recording and pressing an end key ends the message recording.

5. The portable reminder device according to claim 1, wherein the microprocessor and the memory provides for a plurality of messages to be created and automatically indicated by at least one reminder notification.

6. The portable reminder device according to claim 1, wherein said audio processing system digitize a message, said microprocessor receives the digitized message, and said microprocessor causes said memory to store said digitized message.

7. The portable reminder device according to claim 1, wherein said microprocessor recognizes audible entry of the day of the week a recorded message is to be played back.

8. The portable reminder device according to claim 1, wherein said microprocessor operates in a plurality of operating modes.

9. The portable reminder device according to claim 8, wherein said plurality of operating modes includes a vibration mode wherein sound is suppressed and vibrations are used for signaling.

10. The portable reminder device according to claim 1, further including a display operatively connected to said microprocessor, said display for presenting visual messages to a user.

12. The portable reminder device according to claim 1, further including at least one LED for visually signaling an operating mode and a reminder alert mode.

13. The portable reminder device according to claim 1, further including a playback key operatively connected to said microprocessor, said microprocessor causing a recorded message to be played back when activated.

14. The portable reminder device according to claim 13, wherein the first recorded message is played back when in said playback key is activated.

15. The portable reminder device according to claim 1, said motion sensor senses movement around said portable reminder device.

16. The portable reminder device according to claim 1, wherein said clock system automatically obtains current time from an external source.

17. The portable reminder device according to claim 1, wherein said motion sensor senses movement within about less than five feet away from the device.

18. The portable reminder device according to claim 1, further including a magnet to attach said portable reminder device to a ferro-magnetic object.

19. The portable reminder device according to claim 1, further including an adhesive strip for attaching said portable reminder device to a surface.

20. A method for automated reminders comprising the steps of:
providing a portable reminder device operable for providing automatic reminder alerts having an audio notification and/or a visual notification;
activating the portable reminder device;
creating a new reminder on the portable reminder device;
activating a motion sensor on the portable reminder device so that when motion is detected, the portable motion sensor device automatically activates at least one reminder notification or alert.

21. The method of claim 20, wherein the step of automatically activating at least one reminder notification or alert further includes the step of automatically generating an audible signal.

22. The method of claim 20, wherein the step of automatically activating at least one reminder notification or alert further includes the step of automatically generating a visual signal.

23. The of claim 20, wherein the step of automatically activating at least one reminder notification or alert further includes the step of automatically activating an alert if no motion has been sensed within a predetermined timeframe (e.g., one week).
